(19) United States
(12) Patent Application Publication
(10) Pub. No.: US 2023/0315536 A1
(43) Pub. Date: Oct. 5, 2023

(54) DYNAMIC REGISTER RENAMING IN HARDWARE TO REDUCE BANK CONFLICTS IN PARALLEL PROCESSOR ARCHITECTURES

(71) Applicant: ADVANCED MICRO DEVICES, INC., Santa Clara, CA (US)

(72) Inventors: Mark Wyse, Bellevue, WA (US); Bradford Michael Beckmann, Bellevue, WA (US); John Kalamatianos, Boxborough, MA (US); Anthony Thomas Gutierrez, Bellevue, WA (US)

(21) Appl. No.: 17/708,021

(22) Filed: Mar. 30, 2022

(51) Int. Cl. G06F 9/50

(52) U.S. Cl. CPC G06F 9/5077

(57) ABSTRACT

To reduce inter- and intra-instruction register bank access conflicts in parallel processors, a processing system includes a remapping circuit to dynamically remap virtual registers to physical registers of a parallel processor during execution of a wavefront. The remapping circuit remaps virtual registers to physical registers at a register mapping table that holds the current set of virtual to physical register mappings based on a list of available registers indicating which physical registers are available for a new mapping and a register mapping policy.

This invention was made with government support under the PathForward Project with Lawrence Livermore National Security (Prime Contract No. DE-AC52-07NA27344, Subcontract No. B620717) awarded by Department of Energy (DOE). The Government has certain rights in this invention.

### BACKGROUND

Processing systems often include a parallel processor to process graphics and perform video processing operations, to perform machine learning operations, and so forth. In order to efficiently execute such operations, the parallel processor divides the operations into threads and groups of similar threads, such as similar operations on a vector or array of data, into sets of threads referred to as wavefronts. The parallel processor executes the threads of one or more wavefronts in parallel at different compute units of the parallel processor. Processing efficiency of the parallel processor can be enhanced by increasing the number of wavefronts that are executing or ready to be executed at the compute units at a given point in time. However, the number of wavefronts that can be executed is limited by the resources available at the parallel processor. For example, multiple wavefronts, or a single instruction within a wavefront, may attempt to access registers residing in the same physical bank of a register file in the same cycle, resulting in a bank access conflict.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system including a parallel processing unit configured to remap architected registers to physical register and banks of a register file to avoid bank access conflicts in accordance with some embodiments.

FIG. 2 is a block diagram of a remapping module applying a remapping policy to remap virtual registers to available physical registers in response to detecting a bank conflict in accordance with some embodiments.

FIG. 3 is a block diagram of a portion of a remapping module applying a remapping policy to remap virtual registers to available physical registers based on bank activity in accordance with some embodiments.

FIG. 4 is a flow diagram illustrating a method for remapping virtual registers to available physical registers to avoid bank access conflicts in accordance with some embodiments.

### DETAILED DESCRIPTION

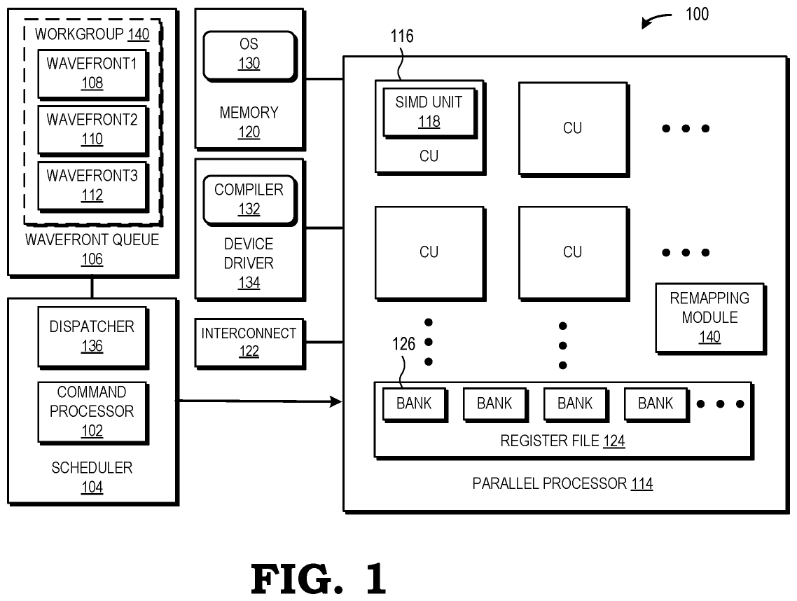

FIGS. 1-4 illustrate techniques for reducing inter- and intra-instruction register bank access conflicts in parallel processors by dynamically remapping virtual registers to physical registers. In a system that includes registers in a banked register file, a bank access conflicts occur when instructions require access to unique registers from the same register file bank in the same cycle. Bank access conflicts may occur when either reading or writing registers. Such conflicts force some of the access requests to be delayed, or stalled, and reattempted at a later time. Consequently, if an instruction is waiting to execute but it is unable to read an operand from the register file due to a bank conflict, that instruction must stall for at least one cycle until the read operation can be reattempted. These stalls decrease the instruction issue rate and increase latency of the processor. Stalling on reading and writing to register files applies equally to scalar and vector registers, for any type of instruction (e.g., memory, arithmetic, etc.).

During register allocation, a compiler of a processing system including one or more parallel processing units uses information regarding the sizes of physical register files and any alignment or allocation restrictions imposed by the hardware and architecture of the parallel processing units to allocate some number of physical registers to each wavefront. The total number of registers used by all wavefronts of a workgroup must be less than or equal to the available number of physical registers. When a workgroup is dispatched, each wavefront of the workgroup has physical registers allocated to it as a contiguous block in the physical register file. For example, the mapping of virtual to physical registers is specified in some cases by a base offset into the physical register file plus a virtual register index. Once the virtual registers have been allocated and mapped to the physical register file, the mapping is fixed for the lifetime of the wavefront.

However, a static mapping of virtual to physical registers can result in bank conflicts. For example, if one instruction in a sequence of instructions executing within a loop that is to perform a very large number of iterations accesses two source operands, A and B, that each require one physical register that are stored in the same physical register bank and one or both of which are updated at every iteration of the loop, at each iteration of the loop, when A and B are accessed, the accesses must be serialized. Such serialization adds at least one cycle to the execution of the accessing instruction, adding at least N cycles for N iterations of the loop, and potentially introduces stalls for subsequent instructions that need to access the same register banks as well.

In addition, once a virtual register has been mapped to a physical register and a write to the physical register has occurred, the register is considered “live” until the last read of the value occurs. After the last read and until the next write occurs, the register is considered “dead” and therefore available for re-mapping. However, if the mapping hardware does not know when the last read to the register occurs, the mapping hardware conservatively considers the value stored in the register “live” until another write occurs, which results in treating the register as “live” even though it is already “dead” and unnecessarily withholding the register from a pool of registers available for mapping.

To reduce inter- and intra-instruction register bank access conflicts in parallel processors, a processing system includes a remapping circuit (also referred to as a remapping module) to dynamically remap virtual registers to physical registers during execution of a wavefront. The remapping module includes logic to detect bank conflicts, such as the bank conflict between A and B described above. When A and/or B is updated by a later instruction in the loop, the remapping module remaps A and/or B to different physical register banks based on the detection of the bank conflict. In subsequent iterations of the loop, accesses to A and B now occur in parallel and do not introduce a bank conflict stall, improving the instruction issue rate and overall performance of the parallel processing unit.

In some embodiments, the processing system remaps (i.e., renames) virtual registers to physical registers at a register mapping table (also referred to herein as a mapping table) that holds the current set of virtual to physical register mappings based on a list of available registers indicating which physical registers are available for a new mapping and a register mapping policy. In some embodiments, the list of available registers employs a bitset with one bit per physical register per bank. If the bit is set, the corresponding physical register is available as a remapping target, whereas if the bit is unset, the corresponding physical register is currently reserved by a virtual register and is unavailable as a remapping target.

The mapping table contains a number of entries equal to the number of physical registers in a register file, with each entry including a valid bit and a physical register index in some embodiments. The index points to a physical location in the register file where a virtual register resides based on the current mapping. The processing system modifies the index to remap the virtual register to another available physical register anywhere in the register file. Because the mapping table holds one entry for every physical register in the register file, the mapping table can remap any virtual register to any physical location in the register file. In some embodiments, the processing system assigns each wavefront to a contiguous set of entries in the mapping table such that if a wavefront requires L registers, the wavefront is assigned entries 0 to L-1 in the mapping table.

In other embodiments, the mapping table holds a number of entries less than the number of physical registers in a register file. Each entry in the mapping table includes a valid bit and a register bank index rather than the physical register index. A register is restricted to reside in only K locations in the register file, where K is the number of register banks, with one location per bank per register. The location is the same across all banks per register. Alternatively, the mapping table is set associative and includes M entries, where M<N (N is the number of registers in the register file), and each entry holds a tag, a valid bit, and a physical register index, where the tag is a combination of a wavefront identifier (wavefront ID) and a virtual register index. To remap virtual to physical registers, the processing system performs a tag comparison and valid bit check. If a matching tag is found and the valid bit is set, the processing system retrieves the register file location and uses it to remap the virtual register. In some embodiments, the processing system tracks the register bank rather than the register index, allowing one location per bank for each remapped register.

The register mapping policy determines when to perform register remapping and how to map virtual to physical registers. In some embodiments, the register mapping policy employed by the processing system is to remap virtual to physical registers of a parallel processing unit on every write to each physical register. In other embodiments, the register mapping policy is to only selectively remap virtual to physical registers of a parallel processing unit. For example, one method of selective remapping is to require each register to receive a dynamic mapping at least one time (e.g., on the first write to the physical register) and then optionally on subsequent writes, depending on the algorithm employed by the register mapping policy. In some embodiments, only a subset of the virtual registers are dynamically remapped, while the remaining virtual registers are statically mapped to physical registers.

The register mapping policy in some embodiments specifies that a target (remapped) physical register is selected based on recent read activity of each bank of the register file. In some embodiments, the processing system selects a target physical register from the register file bank having the least recent activity. If no register is available in the preferred bank, the processing system selects a physical register from the bank with the next lowest activity for remapping. In some embodiments, the activity level of a bank is tracked by a saturating counter.

In some embodiments, the register mapping policy selects target physical registers and banks according to a round-robin algorithm. In other embodiments, the register mapping policy selects a register from a bank that has the least number of uses by instructions present in a wavefront's instruction buffer. Other embodiments of the register mapping policy track a sliding window of bank accesses and map virtual registers to the bank least used in the window. Alternatively, the register mapping policy maps virtual registers to multiple physical registers in different banks, allowing future register reads to select the bank that does not conflict with other accesses when performing the read.

To facilitate dynamic register remapping, in some embodiments a compiler provides hints to the hardware remapping module indicating that a given register will not be read again, such that the value held by the register is “dead”. The processing system uses the compiler-provided hints to delete virtual to physical register mappings prior to the next write occurring and to update the list of available registers in each bank, invalidating existing mappings that use the register and making the register available for future instructions.

FIG. 1 illustrates a block diagram of a processing system 100 including a parallel processor 114 that remaps architected (virtual) registers to physical register and banks of a register file to avoid bank access conflicts in accordance with some embodiments. The processing system 100 supports the execution of computer instructions at an electronic device, such as a desktop computer, laptop computer, server, game console, smartphone, tablet, and the like. Components of processing system 100 are implemented as hardware, firmware, software, or any combination thereof. In some embodiments, the processing system 100 includes one or more software, hardware, and firmware components in addition to or different from those shown in FIG. 1, including one or more additional parallel processors, memory modules external to the processing system, and the like, that together support the execution of computer instructions.

A parallel processor is a processor that is able to execute a single instruction on multiple data or threads in a parallel manner. Examples of parallel processors include processors such as graphics processing units (GPUs), massively parallel processors, single instruction multiple data (SIMD) architecture processors, and single instruction multiple thread (SIMT) architecture processors for performing graphics, machine intelligence or compute operations. In some implementations, parallel processors are separate devices that are included as part of a computer. In other implementations such as advance processor units, parallel processors are included in a single device along with a host processor such as a central processor unit (CPU). The embodiments and implementations described below are applicable to both GPUs and other types of parallel processors.

To support execution of operations, the processing system 100 includes a scheduler 104 and a wavefront queue 106. The scheduler 104 includes a dispatcher 136 and a command processor (CP) 102. The dispatcher 136 assigns unique IDs to each dispatched wavefront and maintains a list of available registers at a register file 124. The CP 102 delineates the operations to be executed at the parallel processor 114. In particular, the CP 102 receives commands (e.g., draw commands) from another processing unit (not shown) such as a central processing unit (CPU). Based on a specified command architecture associated with the parallel processor 114, the CP 102 interprets a received command to generate one or more sets of operations, wherein each set of operations is referred to herein as a wavefront (also referred to as a warp). Thus, each wavefront is a set of data that identifies a corresponding set of operations to be executed by the parallel processor 114, including operations such as memory accesses, mathematical operations, communication of messages to other components of the processing system 100, and the like. The CP 102 stores each wavefront (e.g., wavefronts 108, 110) at the wavefront queue 106.

The parallel processor 114 executes commands and programs for selected functions, such as graphics operations and other operations that are particularly suited for parallel processing. In general, parallel processor 114 is frequently used for executing graphics pipeline operations, such as pixel operations, geometric computations, and rendering an image to a display. In some embodiments, the parallel processor 114 also executes compute processing operations (e.g., those operations unrelated to graphics such as video operations, physics simulations, computational fluid dynamics, etc.), based on commands or instructions received from the CPU (not shown). For example, such commands include special instructions that are not typically defined in the instruction set architecture (ISA) of the parallel processor 114. In some embodiments, the parallel processor 114 receives an image geometry representing a graphics image, along with one or more commands or instructions for rendering and displaying the image. In various embodiments, the image geometry corresponds to a representation of a two-dimensional (2D) or three-dimensional (3D) computerized graphics image.

In various embodiments, the parallel processor 114 includes one or more compute units (CUs), such as CU 116, that include one or more single-instruction multiple-data (SIMD) units, such as SIMD unit 118, that are each configured to execute a number of threads in a wavefront concurrently with execution of other threads in other wavefronts by other SIMD units, e.g., according to a SIMD execution model. The SIMD execution model is one in which multiple processing elements share a single program control flow unit and program counters (not shown) and thus execute the same program in lock step but are able to execute that program with different data. The CUs 116 are also referred to as shader cores or streaming multi-processors (SMXs). The number of CUs 116 implemented in the parallel processor 114 is configurable. Each CU 116 includes one or more processing elements such as scalar and or vector floating-point units, arithmetic and logic units (ALUs), and the like. In various embodiments, the CUs 116 also include special-purpose processing units (not shown), such as inverse-square root units and sine/cosine units.

Each of the one or more CUs 116 executes a respective instantiation of a particular work item to process incoming data, where the basic unit of execution in the one or more CUs 116 is a work item (e.g., a thread). Each work item represents a single instantiation of, for example, a collection of parallel executions of a kernel invoked on a device by a command that is to be executed in parallel. As referred to herein, a kernel is a function containing instructions declared in a program and executed on an accelerated processing device (APD) CU 116. A work item executes at one or more processing elements as part of a workgroup executing at a CU 116.

The parallel processor 114 executes work-items, such as groups of threads executed simultaneously as a “wavefront”, on a single SIMD unit. Wavefronts, in at least some embodiments, are interchangeably referred to as warps, or vectors. In some embodiments, wavefronts include instances of parallel execution of a shader program, where each wavefront includes multiple work items that execute simultaneously on a single SIMD unit in line with the SIMD paradigm (e.g., one instruction control unit executing the same stream of instructions with multiple data). The scheduler 104 is configured to perform operations related to scheduling various wavefronts on different CUs 116 and SIMD units and performing other operations to orchestrate various tasks on the parallel processor 114.

To reduce latency associated with off-chip memory access, various parallel processor architectures include resources such as a register file 124, a memory cache hierarchy (not shown) including, for example, L1 cache and a local data share (LDS). The LDS is a high-speed, low-latency memory private to each CU 116. In some embodiments, the LDS is a full gather/scatter model so that a workgroup reads/writes anywhere in an allocated space. The register file 124 is a memory structure that includes a plurality of registers arranged in banks, such as bank 126. Each bank 126 can only support a single access (i.e., a read or a write) at any given time. Thus, if there are two or more pending accesses to a bank 126, one of the accesses will have to wait until the other access has been performed before it can access the register file. In some embodiments, the register file 124 is a vector register file, and in other embodiments the register file 124 is a scalar register file. The register file 124 is a shared resource between all the wavefronts executing on the same SIMD unit 118.

The parallelism afforded by the one or more CUs 116 is suitable for graphics-related operations such as pixel value calculations, vertex transformations, tessellation, geometry shading operations, and other graphics operations. A graphics processing pipeline (not shown) accepts graphics processing commands from the CPU and thus provides computation tasks to the one or more CUs 116 for execution in parallel. Some graphics pipeline operations, such as pixel processing and other parallel computation operations, require that the same command stream or compute kernel be performed on streams or collections of input data elements. Respective instantiations of the same compute kernel are executed concurrently on multiple SIMD units in the one or more CUs 116 to process such data elements in parallel.

A driver, such as device driver 134, communicates with a device (e.g., parallel processor 114) through an interconnect or the communications infrastructure 122. When a calling program invokes a routine in the device driver 134, the device driver 134 issues commands to the device. Once the device sends data back to the device driver 134, the device driver 134 invokes routines in an original calling program. In general, device drivers are hardware-dependent and operating-system-specific to provide interrupt handling required for any necessary asynchronous time-dependent hardware interface. In some embodiments, a compiler 132 is embedded within device driver 134. The compiler 132 compiles source code into program instructions as needed for execution by the processing system 100. During such compilation, the compiler 132 applies transformations to program instructions at various phases of compilation. In other embodiments, the compiler 132 is a stand-alone application. In various embodiments, the device driver 134 controls operation of the parallel processor 114 by, for example, providing an application programming interface (API) to software executing at the CPU to access various functionality of the parallel processor 114.

Within the processing system 100, the memory 120 includes non-persistent memory, such as DRAM (not shown). In various embodiments, the memory 120 stores processing logic instructions, constant values, variable values during execution of portions of applications or other processing logic, or other desired information. For example, in various embodiments, parts of control logic to perform one or more operations on the CPU reside within the memory 120 during execution of the respective portions of the operation by the CPU. During execution, respective applications, operating system functions, processing logic commands, and system software reside in the memory 120. Control logic commands that are fundamental to operating system 130 generally reside in the memory 120 during execution. In some embodiments, other software commands (e.g., a set of instructions or commands used to implement the device driver 134) also reside in the memory 120 during execution of processing system 100.

The scheduler 104 is a set of circuitry that manages scheduling of wavefronts at the parallel processor 114. In response to the CP 102 storing a wavefront at the wavefront queue 106, the scheduler 104 determines, based on a specified scheduling protocol, a subset of the CUs 116 to execute the wavefront. In some embodiments, a given wavefront is scheduled for execution at multiple compute units. That is, the scheduler 104 schedules the wavefront for execution at a subset of compute units, wherein the subset includes a plurality of compute units, with each compute unit executing a similar set of operations. The scheduler 104 further allocates a subset of the registers of the register file 124 for use by the wavefront. The parallel processor 114 is thereby able to support execution of wavefronts for large sets of data, such as data sets larger than the number of processing elements of an individual compute unit.

As noted above, the scheduler 104 selects the particular subset of CUs 116 to execute a wavefront based on a specified scheduling protocol. The scheduling protocol depends on one or more of the configuration and type of the parallel processor 114, the types of programs being executed by the associated processing system 100, the types of commands received at the CP 102, and the like, or any combination thereof. In different embodiments, the scheduling protocol incorporates one or more of a number of selection criteria, including the availability of a given subset of compute units (e.g., whether the subset of compute units is executing a wavefront), how soon the subset of compute units is expected to finish executing a currently-executing wavefront, a specified power budget of the processing system 100 that governs the number of CUs 116 that are permitted to be active, the types of operations to be executed by the wavefront, the availability of registers of the register file 124 of the parallel processor 114, and the like.

The scheduler 104 further governs the timing, or schedule, of when each wavefront is executed at the compute units 116. For example, in some cases the scheduler 104 identifies that a wavefront (such as wavefront1 108) is to be executed at a subset of compute units that are currently executing another wavefront (such as wavefront2 110 or wavefront3 112). The scheduler 104 monitors the subset of compute units to determine when the compute units have completed execution of wavefront2 110 or wavefront3 112. In response to wavefront2 110 or wavefront3 112 completing execution, the scheduler 104 provides wavefront1 108 to the subset of compute units, thereby initiating execution of wavefront1 108 at the subset of compute units.

To facilitate avoiding bank access conflicts at the register file 124 of the parallel processor 114, the processing system 100 includes a remapping module 140. Bank read conflicts can occur between registers read by the same instruction (intra-instruction), because some instructions have multiple source operands, and can also occur between registers read by different instructions (inter-instruction) when those instructions from different wavefronts are issued in the same cycle or in successive cycles. Bank write conflicts can occur between registers written by instructions from different wavefronts (inter-instruction) when multiple wavefronts execute concurrently and share the register file 124. Further, wavefronts from the same kernel are likely to access the same virtual vector registers close in time, as the wavefronts are executing the same program, are created at the same time, and may have synchronized execution using inter-workgroup operations (e.g., barriers).

The remapping module 140 is programmed to detect bank access conflicts and remap virtual registers to physical registers across different physical register banks 126. The remapping module 140 remaps the virtual registers to physical registers based on a list of available physical registers (not shown) and a remapping policy (not shown). In some embodiments, the remapping module 140 remaps virtual registers to physical registers at a mapping table (not shown) that holds the current set of virtual to physical register mappings. The remapping module 140 remaps the virtual registers to physical registers based on a list of available registers (not shown) and a register mapping policy (not shown). The register mapping policy determines when to perform register remapping and how to map virtual to physical registers. By remapping virtual to physical registers in response to detecting bank access conflicts, the remapping module 140 increases the instruction issue rate and overall performance of the parallel processor 114.

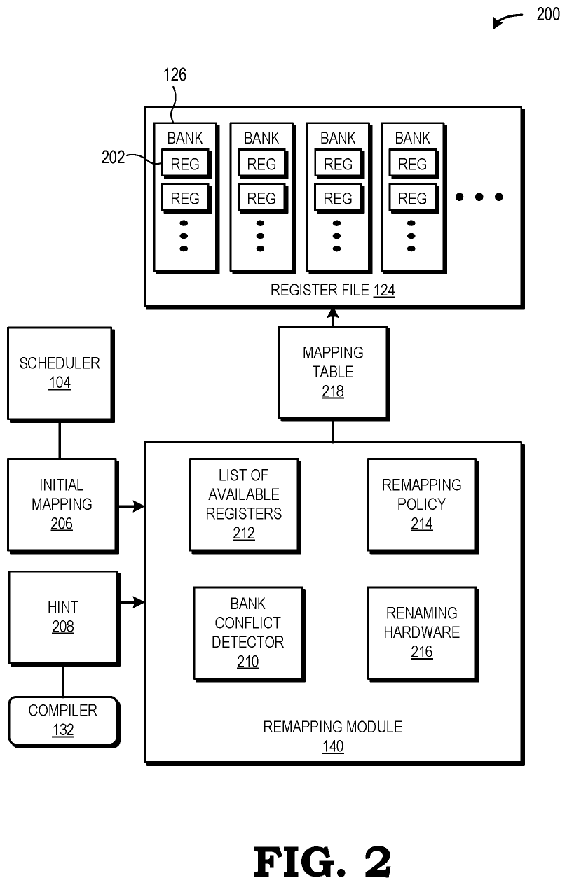

FIG. 2 is a block diagram 200 illustrating the remapping module 140 applying a remapping policy 214 to remap virtual registers to available physical registers in response to detecting a bank conflict for one or more wavefronts accessing registers, such as physical register 202, of the register file 124 in accordance with some embodiments. The remapping module includes bank conflict detector 210, a list of available registers 212, the remapping policy 214, and renaming hardware 216. Components of remapping module 140 are implemented as hardware, firmware, software, or any combination thereof. The remapping module 140 receives an initial mapping 206 of virtual registers to physical registers from the scheduler 104. In some embodiments, the compiler 132 also provides one or more hints, such as hint 208, indicating that a last read to a physical register has occurred and the physical register can now be considered “dead” and therefore available for allocation to another virtual register. Based on detected bank access conflicts, the remapping module generates and dynamically updates a mapping table 218 mapping virtual registers to physical registers 202 at different banks 126 of the register file 124 during execution of one or more wavefronts.

The bank conflict detector 210 is configured to detect bank access conflicts at the register file 124. For example, if a single instruction, executed inside a loop, accesses two source operands that are stored at the same physical register bank, such as bank 126, the bank conflict detector 210 detects the bank conflict at the first iteration of the loop. Based on the detection of the bank conflict by the bank conflict detector 210, the remapping module 140 accesses the list of available registers 212 to determine if a physical register is available in another bank of the register file 124 for remapping.

The list of available registers 212 indicates which of the physical registers 202 have been reserved and which of the physical registers 202 are available for a new mapping to a virtual register. In some embodiments, the list of available registers 212 includes a bit per physical register per bank of the register file 124. If the bit is set, the corresponding physical register 202 is available as a remapping target. If the bit is unset, the physical register 202 is currently mapped to a virtual register.

The remapping policy 214 specifies when and how to perform remapping of virtual to physical registers. In some embodiments, the remapping policy 214 is to perform remapping on every write to each physical register 202. In other embodiments, the remapping policy 214 is to selectively remap virtual to physical registers at each write to each physical register 202. For example, in some embodiments, the remapping policy 214 is to require each physical register 202 to receive a new mapping at least one time (such as on the first write to the physical register 202) and then optionally on subsequent writes. In some embodiments, the remapping policy 214 specifies that only a subset of the virtual registers is dynamically remapped, while the remaining virtual registers remain statically mapped to physical registers 202.

The renaming hardware 216 dynamically updates the mapping table 218 in response to an indication from the bank conflict detector 210 that a bank access conflict has been detected for one or more wavefronts. The renaming hardware 216 updates the mapping table 218 based on the list of available registers 212 and the remapping policy 214 to remap virtual registers to physical registers in different banks so that accesses to physical registers 202 for a given instruction or for groups of instructions in a wavefront can occur in parallel.

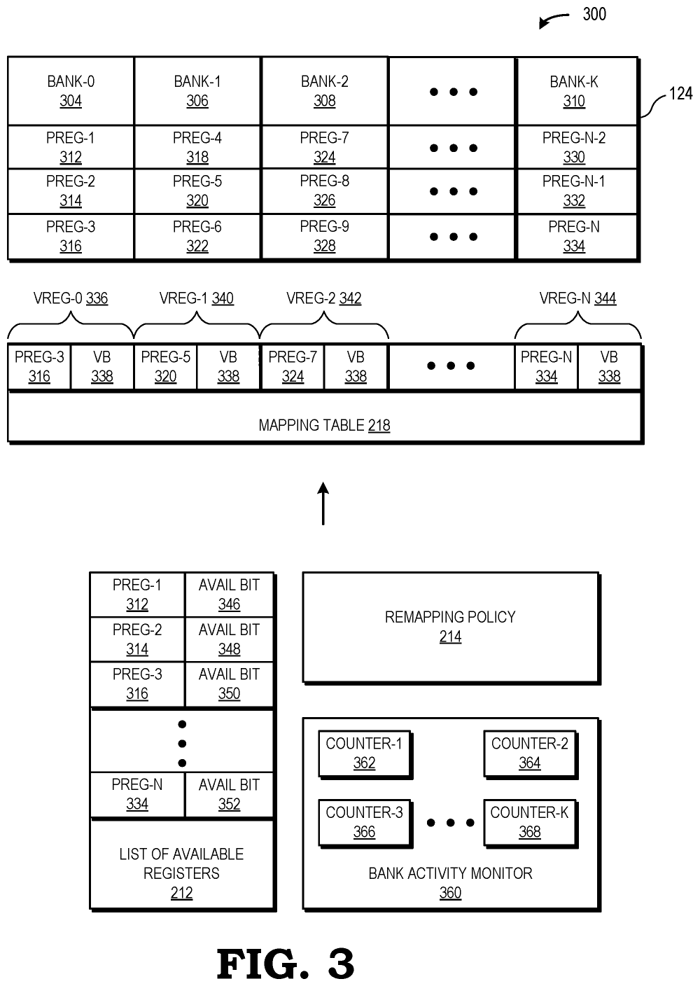

FIG. 3 is a block diagram 300 of a portion of a remapping module 140 applying a remapping policy 214 to remap virtual registers to available physical registers at the mapping table 218 based on bank activity in accordance with some embodiments. In the illustrated example, the register file 124 includes N physical registers arranged in K banks: bank-0 304, bank-1 306, bank-2 308, . . . , and bank-K 310. In the illustrated example, bank-0 304 includes physical registers PREG-1 312, PREG-2 314, and PREG-3 316; bank-1 306 includes registers PREG-4 318, PREG-5 320, and PREG-6 322; bank-2 308 includes registers PREG-7 324, PREG-8 326, and PREG-9 328, and bank-K 310 includes PREG-N-2 330, PREG-N-1 332, and PREG-N 334.

The list of available physical registers 212 includes an entry of each physical register and an available bit indicating whether the corresponding physical register is available as a remapping target or is currently reserved by a virtual register. In the illustrated example, the list of available registers 212 includes a list of each of the physical registers of the register file 124 and the corresponding available bit, such that register PREG-1 312 corresponds to available bit 346, register PREG-2 314 corresponds to available bit 348, register PREG-3 316 corresponds to available bit 350, and register PREG-N 334 corresponds to available bit 352. In some embodiments, if the available bit is set to 1, the corresponding register is available as a remapping target, and if the available bit is unset (e.g., has a value of 0), the corresponding register is currently reserved by a virtual register.

In some embodiments, the remapping module 140 includes a bank activity monitor 360. The bank activity monitor tracks accesses to registers at each of the banks 304, 306, 308, 310 of the register file 124. In some embodiments, the bank activity monitor 360 includes a saturating counter of L bits (e.g., L=8) associated with each bank. Thus, in the illustrated example, saturating counter-1 362 is associated with bank-0 304, saturating counter-2 364 is associated with bank-1 306, saturating counter-3 366 is associated with bank-2 308, and saturating counter-K 368 is associated with bank-K 310. Each time a bank is read from, the saturating counter associated with the bank is incremented by a value X (e.g., X=3). When a bank is not the target of a read in a given cycle and at least one other bank is read from that cycle, the counter associated with the bank that was not read from is decremented by a value Y (e.g., Y=1).

The remapping module 140 generates and dynamically updates the mapping table 218 based on the list of available physical registers 212, information generated by the bank activity monitor 350, and the remapping policy 214. Thus, the remapping module 140 creates a virtual to physical register mapping by finding an available physical register using list of available physical registers 212, the remapping policy 214 and, in some embodiments, the bank activity monitor 350, and writing the mapping into the mapping table 218 at the entry for the virtual register. The mapping table 218 is indexed with a virtual register to retrieve a physical register ID that is then used to perform the read/write operation. In the illustrated example, the physical register file 124 has N physical registers and the mapping table 218 has N entries, such that up to N virtual registers can each be mapped to one physical register. In some embodiments, each entry of the mapping table 218 includes a valid bit 338 and a physical register index that points to the physical location in the register file 124 where the virtual register value resides based on the current mapping. The index can be modified to remap the virtual register to any physical register in the register file 124 in some embodiments.

In other embodiments, each entry in the mapping table 218 holds a valid bit 338 and a register bank index instead of a register index, such that a virtual register is allowed to be mapped to only K locations in the register file 124, where K is the number of register banks (i.e., each virtual register can only be mapped to the physical register entry with index K per bank). In some embodiments, the mapping table 218 includes M entries, where M<N (N=the number of registers in the register file 124), and each entry holds a tag, a valid bit, and a register index. In some embodiments, the tag is a combination of the wavefront ID and the virtual register index, where the register index is the physical register index. The mapping table 218 in such embodiments is set associative, similar to a set-associative traditional cache, and requires the remapping module 140 to perform a tag comparison and valid bit check. If a matching tag is found and the valid bit is set, the processing system retrieves the register file location and uses it to remap the virtual register. If the matching tag is not found, or the valid bit is not set, the initial mapping 206 is used.

In some embodiments, the remapping module 140 selects the bank with the lowest counter value as the target bank for renaming a virtual register, as long as the bank with the lowest counter value has at least one free register as indicated by the list of available registers 212. If no register is available in the bank with the lowest counter value, the remapping module 140 attempts to remap the virtual register to the bank with the next lowest activity, and so on, until an available register is found. Because the mapping table 218 includes an entry for each register of the register file 124, a register will be found.

In the illustrated example, the mapping table 218 maps the virtual registers to physical registers of different banks in a round-robin order, such that the first entry for a renamed register VREG-1 336 targets bank-0 304, the second entry for a renamed register VREG-2 340 targets bank-1 306, the third renamed register targets bank-2 308, and so on, until the Nth renamed register targets bank-3 310, wrapping back around to bank-0 304. Thus, the mapping table 218 maps the virtual register VREG-0 336 to PREG-3 316 in bank-0 304, the virtual register VREG-1 340 to PREG-5 320 in bank-1 306, and the virtual register VREG-2 to reg-9 328 in bank-2 308. The mapping table 218 continues reserving available physical registers for virtual registers until the last of the virtual registers, VREG-N 344 is mapped to PREG-N 334 in bank-K 310 in the illustrated example.

Thus, if the initial mapping 206 assigned contiguous physical registers in the register file 124 to a wavefront, the initial mapping 206 in the illustrated example would likely encounter a number of bank access conflicts. However, when the initial mapping to contiguous physical registers is remapped according to the mapping table 218, the contiguous virtual registers are distributed among the banks 304, 306, 308, 310 of the register file 124 such that bank access conflicts are less likely for intra- and inter-wavefront accesses.

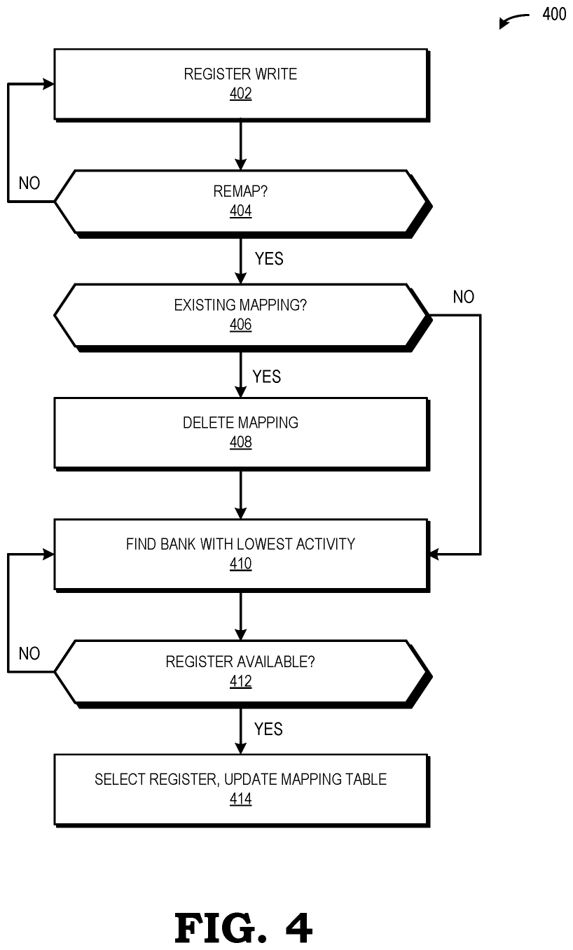

FIG. 4 is a flow diagram illustrating a method 400 for remapping virtual registers to available physical registers to avoid bank access conflicts in accordance with some embodiments. The method 400 is described with respect to an example implementation at the processing system 100 of FIG. 1. At block 402, execution of a wavefront causes a write to a virtual register. At block 404, the remapping module 140 determines whether to remap a virtual register to a physical register in response to the register write. In some embodiments, the remapping policy is to remap a virtual to a physical register at every register write. In some embodiments, the bank conflict detector 210 determines that a bank access conflict exists and signals the remapping module 140 to remap a virtual register to a different physical register.

If, at block 404, the remapping module 140 determines not to remap virtual to physical registers, the method flow continues back to block 402. If the remapping module 140 determines to remap a virtual register to a physical register at block 404, the method flow continues to block 406. At block 406, the remapping module 140 determines whether a mapping exists for the virtual register under consideration. If, at block 406, the remapping module 140 determines that a mapping already exists for the virtual register, the method flow continues to block 408. At block 408, the remapping module 140 deletes the existing virtual to physical register mapping and the method flow continues to block 410. If, at block 406, the remapping module 140 determines that a mapping does not already exist for the virtual register, the method flow continues to block 410.

At block 410, the remapping module 140 finds the register bank with the lowest activity. For example, in some embodiments, the remapping module 140 receives a signal from the bank activity monitor 350 indicating which bank has the lowest activity, based on saturating counters associated with each bank. In some embodiments, if there is a recurring bank conflict within a single instruction, the remapping module 140 remaps the operands to separate banks without regard to the activity levels of the banks. At block 412, the remapping module 140 determines whether a register is available at the bank with the lowest activity. For example, in some embodiments, the remapping module 140 determines from the list of available registers 212 whether a register is available at the bank with the lowest activity. If, at block 412, the remapping module 140 determines that a register is not available at the bank with the lowest activity, the method flow continues back to block 410, at which the remapping module 140 finds the bank with the next-lowest activity. In some embodiments, the remapping module 140 searches for the bank with the next-lowest activity in parallel with determining that a register is not available at the bank with the lowest activity. Eventually the loop between block 410 and block 412 checks all the banks and if no other registers are available, the search ends. If, at block 412, the remapping module 140 determines that a register is available at the bank with the lowest activity, the method flow continues to block 414. At block 414, the remapping module 140 selects an available physical register from the bank with the lowest activity and update the mapping table 218 to map the virtual register to the available physical register.

In some embodiments, the apparatus and techniques described above are implemented in a system including one or more integrated circuit (IC) devices (also referred to as integrated circuit packages or microchips), such as the processing system described above with reference to FIGS. 1-4. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method, comprising:
remapping virtual registers to physical registers allocated among a plurality of banks of a physical register file of a parallel processor during execution of a wavefront at the parallel processor, the remapping being based on a subset of physical registers of the physical register file that are available for remapping and a remapping policy.

2. The method of claim 1, further comprising:
storing a set of virtual register to physical register mappings at a mapping table comprising a plurality of entries, each entry comprising a valid bit and a physical register index indicating a first physical location in the physical register file where a virtual register resides.

3. The method of claim 1, further comprising:
storing a set of virtual register to physical register mappings at a mapping table comprising a number of entries fewer than the number of physical registers in the physical register file, each entry comprising a register bank index indicating a register bank in the physical register file where a virtual register resides.

4. The method of claim 3, wherein the remapping policy is to remap the virtual register from a first physical location in the physical register file to a second physical location in the physical register file in response to a write to the first physical location.

5. The method of claim 3, wherein
the remapping policy is to remap the virtual register to a second physical location of a physical register based on an activity level of a bank to which the physical register is allocated.

6. The method of claim 5, wherein the remapping policy selects successive physical registers to be reserved by virtual registers to rotate among the plurality of banks in a round-robin order.

7. The method of claim 1, further comprising:
updating the subset of physical registers of the physical register file that are available for remapping based on a hint received from a compiler indicating that a physical register will not be used again by the wavefront.

8. A method comprising:
maintaining a set of virtual register to physical register mappings for physical registers of a physical register file of a parallel processor during execution of a wavefront at the parallel processor;
maintaining a list indicating a subset of physical registers of the physical register file that are available for remapping; and
remapping virtual registers to physical registers based on the list and a register mapping policy.

9. The method of claim 8, further comprising:
storing the set of virtual register to physical register mappings at a mapping table comprising a plurality of entries, each entry comprising a valid bit and a physical register index indicating a first physical location in the physical register file where a virtual register resides.

10. The method of claim 9, further comprising:
storing the set of virtual register to physical register mappings at a mapping table comprising a number of entries fewer than the number of physical registers in the physical register file, each entry comprising a register bank index indicating a register bank in the physical register file where a virtual register resides.

11. The method of claim 10, wherein the register mapping policy is to remap the virtual register from a first physical location in the physical register file to a second physical location in the physical register file in response to a write to the first physical location.

12. The method of claim 9, wherein
the physical registers of the physical register file are allocated among a plurality of banks; and
the register mapping policy is to remap the virtual register to a second physical location of a physical register based on an activity level of a bank to which the physical register is allocated.

13. The method of claim 12, wherein the register mapping policy selects successive physical registers to be reserved by virtual registers to rotate among the plurality of banks in a round-robin order.

14. The method of claim 8, further comprising:
updating the list indicating the subset of physical registers of the physical register file that are available for remapping based on a hint received from a compiler indicating that a physical register will not be used again by the wavefront.

15. A parallel processor, comprising:
a physical register file comprising a plurality of banks of physical registers, wherein each physical register is allocated to a bank; and
a remapping circuit remapping virtual registers to physical registers during execution of a wavefront at the parallel processor based on a subset of physical registers of the physical register file that are available for remapping and a remapping policy.

16. The parallel processor of claim 15, wherein the remapping circuit is further configured to:
store a set of virtual register to physical register mappings at a mapping table comprising a plurality of entries, each entry comprising a valid bit and a physical register index indicating a first physical location in the physical register file where a virtual register resides.

17. The parallel processor of claim 15, wherein the remapping circuit is further configured to:
store a set of virtual register to physical register mappings at a mapping table comprising a number of entries fewer than the number of physical registers in the physical register file, each entry comprising a register bank index indicating a register bank in the physical register file where a virtual register resides.

18. The parallel processor of claim 15, wherein
the remapping policy is to remap a virtual register to from a first physical location of a first physical register a second physical location of a second physical register based on an activity level of a bank to which each physical register is allocated.

19. The parallel processor of claim 15, wherein the remapping policy selects successive physical registers to be reserved by virtual registers by rotating among the plurality of banks in a round-robin order.

20. The parallel processor of claim 15, wherein the remapping circuit is further to:
update the subset of physical registers of the physical register file that are available for remapping based on a hint received from a compiler indicating that a physical register will not be used again by the wavefront.
